(19) United States
(12) Patent Application Publication
(10) Pub. No.: US 2024/0190414 A1
(43) Pub. Date: Jun. 13, 2024

(54) CONTROL APPARATUS FOR VEHICLE

(71) Applicant: TOYOTA JIDOSHA KABUSHIKI KAISHA, Toyota-shi (JP)

(72) Inventors: Nobuhiro KOTAKE, Toyota-shi (JP); Suguru KUMAZAWA, Nisshin-shi (JP); Kenji GOTODA, Nagakute-shi (JP)

(73) Assignee: TOYOTA JIDOSHA KABUSHIKI KAISHA, Toyota-shi (JP)

(21) Appl. No.: 18/379,293

(22) Filed: Oct. 12, 2023

(30) Foreign Application Priority Data
Dec. 7, 2022 (JP) 2022-195967

(51) Int. Cl. B60W 20/19; B60K 6/26; B60K 6/36; B60K 6/485; B60W 10/08; B60W 10/10

(52) U.S. Cl. CPC B60W 20/19; B60K 6/26; B60K 6/36; B60K 6/485; B60W 10/08; B60W 10/10; B60W 2510/0657; B60W 2710/083; B60W 2720/00; B60Y 2300/18183; B60Y 2300/188; B60Y 2300/69

(57) ABSTRACT

A control apparatus for a vehicle that includes: a drive wheel; an engine; a gear-type power transmission device disposed between the engine and the drive wheel; and a rotary electric machine connected to the gear-type power transmission device in a power transmittable manner. The rotary electric machine is configured to apply a pressing torque in order to suppress rattle noise caused by play between gears of the gear-type power transmission device. The control apparatus is configured to detect an engine torque that is a torque of the engine, and to control the pressing torque based on the detected engine torque.

This application claims priority from Japanese Patent Application No. 2022-195967 filed on Dec. 7, 2022, the disclosure of which is herein incorporated by reference in its entirety.

### FIELD OF THE INVENTION

The present invention relates to a control apparatus for a vehicle, and more particularly to a technique for suppressing gear rattle noise caused by play between gears of a gear-type power transmission device.

### BACKGROUND OF THE INVENTION

There has been proposed a control apparatus for a vehicle that includes a drive wheel, an engine, a gear-type power transmission device disposed between the engine and the drive wheel, and a rotary electric machine connected to the gear-type power transmission device in a power transmittable manner, wherein the rotary electric machine is configured to apply a pressing torque in order to suppress rattle noise caused by play between gears of the gear-type power transmission device. The play between the gears meshing with each other causes backlash of the meshing gears, for example. However, since the gear rattle noise is generated when teeth of the gears collide with each other due to backlash of the gears, the generation of the gear rattle noise can be suppressed by applying the pressing torque such that the teeth of the pair of gears are held in a contact state. Patent Document 1 discloses an example of a device that is configured to change the pressing torque depending on whether the engine is in a warm state or a cold state.

### PRIOR ART DOCUMENT

### Patent Document

### Patent Document 1

Japanese Patent Application Laid-Open No. 2013-91471

### SUMMARY OF THE INVENTION

However, in the above-described prior art, the pressing torque is obtained depending on an operation state of the engine, for example, in accordance with a map determined in advance by an experiment, a simulation or the like. Therefore, the pressing torque is set to a relatively large value so that the rattle noise can be suppressed regardless of individual difference or the like of the engine caused by manufacturing variation or the like. For this reason, a pressing torque larger than necessary is usually applied, and accordingly unnecessary power consumption occurs.

The present invention has been made in view of the above-described circumstances, and an object of the present invention is to reduce the pressing torque for suppressing the rattle noise and to suppress unnecessary power consumption.

According to a first aspect of the present invention, there is provided a control apparatus for a vehicle that includes a drive wheel, an engine, a gear-type power transmission device disposed between the engine and the drive wheel, and a rotary electric machine connected to the gear-type power transmission device in a power transmittable manner. The rotary electric machine is configured to apply a pressing torque in order to suppress rattle noise caused by play between gears of the gear-type power transmission device. The control apparatus is configured to detect an engine torque that is a torque of the engine, and to control the pressing torque based on the engine torque.

According to a second aspect of the invention, in the control apparatus according to the first aspect of the invention, the control apparatus is configured to control the pressing torque, depending on a value of the engine torque, such that the pressing torque is larger when the value of the engine torque is small than when the value of the engine torque is large.

According to a third aspect of the present invention, in the control apparatus according to the first or second aspect of the present invention, the control apparatus is configured to obtain a variation width of the engine torque, and to control the pressing torque, depending on the variation width of the engine torque, such that the pressing torque is larger when the variation width is large than when the variation width is small.

According to a fourth aspect of the present invention, in the control apparatus according to any one of the first through third aspects of the present invention, the vehicle includes a first rotary electric machine and a second rotary electric machine as the rotary electric machine, such that the pressing torque is applied by at least one of the first rotary electric machine and the second rotary electric machine. The gear-type power transmission device is provided with a single-pinion-type planetary gear device including (i) a sun gear connected to the first rotary electric machine, (ii) a carrier connected to the engine via a damper device and (iii) a ring gear, such that the second rotary electric machine is connected between the ring gear and the drive wheel in a power transmittable manner, and such that a power outputted from the engine is distributed to the first rotary electric machine and the ring gear by the planetary gear device, and the power transmitted to the ring gear is outputted toward the drive wheel. The control apparatus is configured to calculate the engine torque in accordance with an arithmetic expression that includes (a) an engine term including an angular acceleration of the engine as a variable, (b) a carrier term including an angular acceleration of the carrier as a variable and (c) a rotary-electric-machine term including an angular acceleration of the first rotary electric machine as a variable.

According to a fifth aspect of the present invention, in the vehicle control apparatus according to the fourth aspect of the present invention, the control apparatus is configured to calculate the engine torque Te in accordance with the following expression using an inertia moment Ie and an angular velocity we of the engine, an inertia moment Ic and an angular velocity ωc of the carrier, an inertia moment Img1, an angular velocity ωmg1 and a torque Tmg1 of the first rotary electric machine, and a gear ratio ρ of the planetary gear device.

Te=Ie*(dωe/dt)+Ic*(dωc/dt)+[(1+ρ)/ρ)*[Img1]*(dωmg1/dt)-Tmg1] (1)

The gear rattle noise due to the play between the gears is generated when the engine torque is reduced or fluctuated. Therefore, where the engine torque is detected and the pressing torque is controlled on the basis of the detected engine torque, it is possible to suppress the gear rattle noise with the minimum necessary pressing torque regardless of the individual difference of the engine or the like, and to suppress unnecessary power consumption.

In the second aspect of the invention, since the pressing torque is controlled in accordance with the value of the engine torque so that the pressing torque becomes larger when the value of the engine torque is small than when the value of the engine torque is large, it is possible to appropriately suppress the rattle noise while suppressing unnecessary power consumption. That is, when the value of the engine torque is small, the positive and negative polarities are reversed due to the torque variation and the gear rattle noise is easily generated. Therefore, by applying a relatively large pressing torque and suppressing the positive and negative polarities from being reversed, it is possible to appropriately suppress the generation of the gear rattle noise.

In the third aspect of the invention, the pressing torque is controlled based on the variation width of the engine torque such that the pressing torque is larger when the variation width of the engine torque is large than when the variation width is small, so that it is possible to appropriately suppress the rattle noise while suppressing the unnecessary power consumption. That is, when the variation width of the engine torque is large, the gear rattle noise is likely to occur due to the torque variation. Therefore, by applying a relatively large pressing torque, it is possible to appropriately suppress the gear rattle noise from generating due to the torque variation.

In the fourth and fifth aspects of the present invention, there is provided the single-pinion-type planetary gear device having (i) the sun gear connected to the first rotary electric machine, (ii) the carrier connected to the engine via the damper device and (iii) the ring gear. The power outputted from the engine is divided between the first rotary electric machine and the ring gear by the planetary gear device, and the power transmitted to the ring gear is outputted toward the drive wheel. In this case, the engine torque Te can be calculated in accordance with the above-described expression (1) including the engine term having the angular acceleration (dωe/dt) of the engine as a variable, the carrier-term having the angular acceleration (dωc/dt) of the carrier as a variable and the rotary-electric-machine term having the angular acceleration (dωmg1/dt) of the first rotary electric machine as a variable. In this case, since the angular acceleration (dωc/dt) of the carrier reflects an input from the drive wheel, the engine torque Te can be detected with high accuracy even during running of the vehicle on a rough road or the like. For this reason, it becomes possible to appropriately detect a reduction or variation of the engine torque Te caused by, for example, a misfire in one cylinder of the engine, and to appropriately suppress generation of the gear rattle noise by controlling the pressing torque based on the engine torque Te.

### BRIEF DESCRIPTION OF THE DRAWINGS

FIG. 1 is a view schematically showing a construction of a vehicle drive system having an electronic control apparatus to which the present invention is applied.

FIG. 2 is a flowchart showing an operation of a pressing-torque calculation portion that is functionally provided in the electronic control apparatus of FIG. 1;

FIG. 3 is a model diagram showing, by way of example, change of an engine torque Te.

FIG. 4 is a view for explaining an example of a map for determining a pressing torque Tp, depending on a value of the engine torque Te.

FIG. 5 is a view for explaining an example of a map for determining the pressing torque Tp, depending on a variation width ΔTe of the engine torque Te.

FIG. 6 is a model diagram for explaining possibility of generation of gear rattle noise even when the variation width ΔTe of the engine torque Te is small.

FIG. 7 is a model diagram for explaining possibility of generation of gear rattle noise even when the engine torque Te is large.

### DETAILED DESCRIPTION OF PREFERRED EMBODIMENT

The engine included in the vehicle to which the present invention is applied is an internal combustion engine that generates power by combustion of fuel, such as a gasoline engine or a diesel engine. The rotary electric machine is an electric motor, a generator or a motor generator that can be alternatively used as the electric motor and the generator. The electric motor and the motor generator can apply the pressing torque by output torque that is positive torque, and the generator and the motor generator can apply the pressing torque by regenerative torque that is negative torque. The engine torque can be calculated, for example, in accordance with the above-described expression (1), but it can also be obtained by another arithmetic expression, or it can be detected by a torque sensor or the like, and various detection methods can be employed. Although the expression (1) is based on a premise that the planetary gear device is provided to be connected to the engine and the rotary electric machine, the provision of the planetary gear device is not essential in the present invention, so that the present invention can be applied to other vehicles provided with an engine, a rotary electric machine and a gear type power transmission device. The pressing torque can be set to a value that is dependent on the value of the engine torque or the variation width of the engine torque, and also to a value that is dependent on both the value of the engine torque and the variation width of the engine torque as variables. The pressing torque may be set or corrected in consideration of a variable other than the engine torque.

### EMBODIMENT

An embodiment of the present invention will be described in detail below with reference to the drawings.

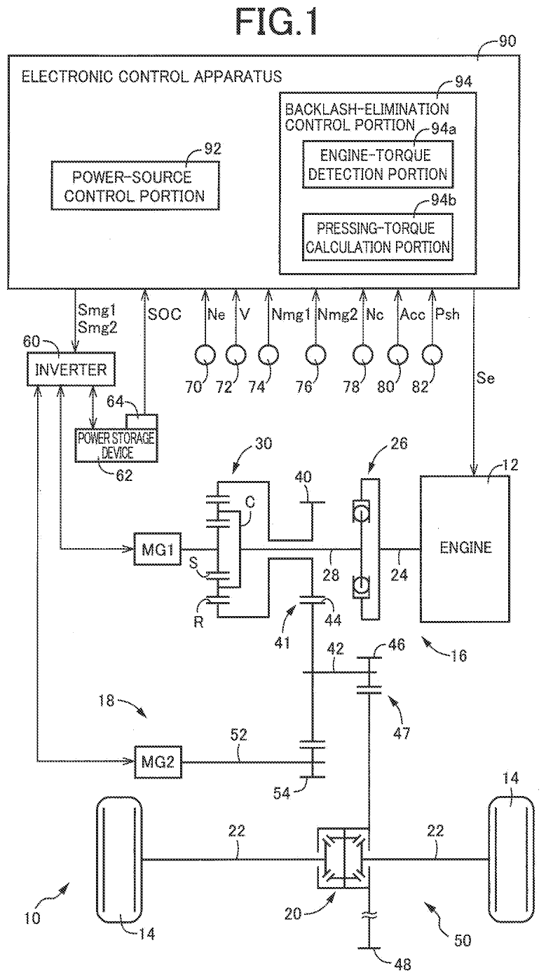

FIG. 1 is a view schematically showing a construction of a drive system of a vehicle 10 having an electronic control apparatus 90 to which the present invention is applied, and is also a view showing a main part of a control system of the vehicle 10. The vehicle 10 has a transverse drive system such as a front-engine front-wheel drive (FF) system. The vehicle 10 includes an engine 12 and right and left drive wheels 14 as a pair of drive wheels. The vehicle 10 further includes a first drive unit 16, a second drive unit 18, a final reduction gear unit 20 and right and left drive shafts 22 as a pair of drive shafts in a power transmission path between the engine 12 and the drive wheels 14. The engine 12 is an internal combustion engine such as a gasoline engine or a diesel engine, and includes a crankshaft 24 to which a damper device 26 is connected for absorbing torque variation.

The first drive unit 16 includes, in addition to the engine 12, a differential mechanism 30, a first rotary electric machine MG1 and an output gear 40. The differential mechanism 30 is a single-pinion-type planetary gear device including three rotary elements consisting of a sun gear S, a ring gear R and a carrier C that are provided in a differentially rotatable manner. The first rotary electric machine MG1 is connected to the sun gear S, the engine 12 is connected to the carrier C via an input shaft 28 and the damper device 26, and the output gear 40 is connected to the ring gear R. Therefore, a torque transmitted from the engine 12 to the carrier C of the differential mechanism 30 via the damper device 26 is divided by the differential mechanism 30 into the first rotary electric machine MG1 and the output gear 40. When the rotational speed (MG1 rotational speed) Nmg1 of the first rotary electric machine MG1 is controlled by regenerative control or the like, the rotational speed (engine rotational speed) Ne of the engine 12 is continuously changed and outputted from the output gear 40 toward the drive wheels 14. That is, the differential mechanism 30 and the first rotary electric machine MG1 function as an electrically-continuously-variable transmission. The first rotary electric machine MG1 is a motor-generator that selectively functions as a motor or a power generator, and is connected to a power storage device 62 such as a battery via an inverter 60.

The output gear 40 meshes with a large-diameter driven gear 44 provided on a counter shaft 42 parallel to the input shaft 28. The output gear 40 and the driven gear 44 are a pair of counter gears 41 meshing with each other. The counter shaft 42 is provided with a small-diameter gear 46 having a smaller diameter than the driven gear 44, and the small-diameter gear 46 is meshed with a differential ring gear 48 of the final reduction gear unit 20. The small-diameter gear 46 and the differential ring gear 48 mesh with each other to constitute a pair of final gears 47. Thus, rotation of the output gear 40 is reduced at a rate based on a gear ratio between the output gear 40 and the driven gear 44 and a gear ratio between the small-diameter gear 46 and the differential ring gear 48, and is transmitted to the final reduction gear unit 20, and further transmitted from the pair of drive shafts 22 to the drive wheels 14 via a differential gear mechanism of the final reduction gear unit 20. The counter gear pair 41, final gear pair 47 and differential mechanism 30 constitute a gear-type power transmission device 50 disposed between the engine 12 and the drive wheels 14.

The second drive unit 18 includes a second rotary electric machine MG2 and a motor output gear 54 provided on a motor shaft 52 of the second rotary electric machine MG2, and the motor output gear 54 meshes with the driven gear 44. Therefore, the rotation of the second rotary electric machine MG2 is reduced at a rate based on a gear ratio between the motor output gear 54 and the driven gear 44 and a gear ratio between the small-diameter gear 46 and the differential ring gear 48, and is transmitted to the final reduction gear unit 20 to rotationally drive the drive wheels 14 via the pair of drive shafts 22. The second rotary electric machine MG2 is a motor-generator that selectively functions as a motor or a power generator, and is connected to the power storage device 62 via the inverter 60. The second rotary electric machine MG2 as well as the engine 12 is used as a power source for driving the vehicle 10. That is, the vehicle 10 is a hybrid electric vehicle including the engine 12 and the second rotary electric machine MG2 as power sources.

In the vehicle 10 constructed as described above, an electronic control apparatus 90 is provided as a control apparatus that executes various controls such as a power control of the engine 12 and a torque control of the rotary electric machines MG1 and MG2. The electronic control apparatus 90 includes a so-called microcomputer having a CPU, a RAM, a ROM, an input/output interface and the like, and executes the various controls by performing signal processing in accordance with a program pre-stored in the ROM while utilizing a temporary storage function of the RAM.

The electronic control apparatus 90 is connected to, for example, an engine speed sensor 70, a vehicle speed sensor 72, an MG1 speed sensor 74, an MG2 speed sensor 76, a carrier speed sensor 78, an accelerator opening degree sensor 80, a shift position sensor 82, an SOC sensor 64 and the like. Signals representing various kinds of information required for control are supplied from these sensors, such as the engine rotational speed Ne, the vehicle running speed V, the MG1 rotational speed Nmg1, an MG2 rotational speed Nmg2 as a rotational speed of the second rotary electric machine MG2, a carrier rotational speed Ne as a rotational speed of the carrier C, an accelerator opening degree Acc as an operation amount of a power-request operation member such as an accelerator pedal, a state-of-charge SOC representing a remaining power amount in the power storage device 62 and a shift position Psh of a shift lever. As the operation position Psh of the shift lever, a D position for forward running, an R position for reverse running, a P position for parking and an N position for neutral are provided, for example. When the shift lever is operated to the D position, a D range in which the forward running is possible is established. When the shift lever is operated to the R position, a R range in which the reverse running is possible is established. When the shift lever is operated to the P position, a P range in which rotation of the drive wheels 14 is mechanically prevented by a parking lock device (not shown) is established. When the shift lever is operated to the N position, an N range in which power transmission to the drive wheels 14 is interrupted is established.

The electronic control apparatus 90 outputs, for example, an engine control signal Se for controlling an engine power via an electronic throttle valve, a fuel injection device and an ignition device of the engine 12, an MG1 control signal Smg1 for controlling an MG1 torque Tmg1 that is a torque (power torque and regenerative torque) of the first rotary electric machine MG1, and an MG2 control signal Smg2 for controlling an MG2 torque Tmg2 that is a torque (power torque and regenerative torque) of the second rotary electric machine MG2, for example.

The electronic control apparatus 90 functionally includes a power-source control portion 92 which calculates a requested drive torque Trdem [Nm] of the drive wheels 14 based on, for example, the accelerator opening degree Acc (that represents a requested output amount) and the vehicle running speed V, and which obtains a target engine torque Tet, a target MG1 torque Tmg1t and a target MG2 torque Tmg2t that can realize the requested drive torque Trdem. Then, the power-source control portion 92 outputs an engine control signal Se for controlling the engine 12 so as to output the target engine torque Tet, an MG1 control signal Smg1 for controlling the first rotary electric machine MG1 so as to output the target MG1 torque Tmg1t, and an MG2 control signal Smg2t for controlling the second rotary electric machine MG2 so as to output the target MG2 torque Tmg2t.

When the requested drive torque Trdem is covered only by the output of the second rotary electric machine MG2, the power-source control portion 92 establishes a BEV running mode in which the vehicle 10 runs by driving the second rotary electric machine MG2 with the electric power from the power storage device 62. In the BEV running mode, the engine 12 is stopped, the MG1 torque Tmg1 of the first rotary electric machine MG1 is set to 0, and the first rotary electric machine MG1 is set to a rotation free state. The power-source control portion 92 establishes a HEV running mode when the requested drive torque Trdem cannot be covered without at least the engine 12. In the HEV running mode, the engine torque Te and the MG1 torque Tmg1 are controlled so as to realize all or a part of the requested drive torque Trdem, and the MG2 torque Tmg2 is controlled so as to compensate an amount that is not covered by only the engine torque Te. Also, in the BEV running mode, the first rotary electric machine MG1 is rotationally driven by the engine 12 as necessary, and the first rotary electric machine MG1 is regeneratively controlled to generate electric power, which is used as a drive electric power for driving the second rotary electric machine MG2 or used to charge the power storage device 62. That is, the engine 12 is an intermittent operation in which the engine 12 is started and stopped for switching of the running mode, power generation or warm-up, for example, during operation of the vehicle 10 in which the vehicle 10 is running or is stopped.

The electronic control apparatus 90 also functionally includes a backlash-elimination control portion 94. That is, in the gear-type power transmission device 50 including the differential mechanism 30, counter gear pair 41 and final gear pair 47, there is backlash or the like due to play among gears, thereby causing a possibility that gear rattle noise could be generated due to the backlash. The backlash-elimination control portion 94 is provided for suppressing the gear rattle, and is configured to apply a predetermined pressing torque Tp so as to keep a contact state in which teeth of the gears meshing with each other are in contact with each other, for thereby eliminating backlash. Since the rattle noise is generated due to reduction or variation of the engine torque Te, the backlash-elimination control portion 94 functionally includes an engine-torque detection portion 94a configured to detect the engine torque Te and a pressing-torque calculation portion 94b configured to calculate the pressing torque Tp based on the engine torque Te.

The engine-torque detection portion 94a calculates an absolute value of the engine torque Te, in accordance with an arithmetic expression including an engine term having an angular acceleration of the engine 12 as a variable, a career term having an angular acceleration of the career C as a variable, and a rotary-electric-machine term having an angular acceleration of the first rotary electric machine MG1 as a variable. More specifically, the engine torque Te is calculated in accordance with the following expression (1) using an inertia moment Ie and the angular velocity ωe of the engine 12, an inertia moment Ic and the angular velocity ωc of the carrier C, an inertia moment Img1, the angular velocity ωmg1 and the torque Tmg1 of the first rotary electric machine MG1, and a gear ratio ρ (=number of teeth of the sun gear S/number of teeth of the ring gear R) of the differential mechanism 30 as the planetary gear device. The angular velocity ωe of the engine 12 corresponds to the engine rotational speed Ne, the angular velocity ωc of the career C corresponds to the career rotational speed Nc, and the angular velocity ωmg1 of the first rotary electric machine MG1 corresponds to the MG1 rotational speed Nmg1. As the torque Tmg1 of the first rotary electric machine MG1, the target MG1 torque Tmg1t obtained by the power-source control portion 92 can be used, but it may be detected by a torque sensor or the like. In the expression (1), “(dωe/dt)” is the angular acceleration of the engine 12, “(dωc/dt)” is the angular acceleration of the carriers C, and “(dωmg1/dt)” is the angular acceleration of the first rotary electric machine MG1.

Te=Ie*(dωe/dt)+Ic*(dωc/dt)+[(1+ρ)/ρ]*[Img1*(dωmg1/dt)-Tmg1] (1)

The above-described expression (1) is obtained using motion equations of the following expressions (2) to (4). The expression (2) is a motion equation related to the engine 12, i.e., the crankshaft 24, where “Tc” is a torque of the carrier C, “Kdamp” is a spring constant of the damper device 26, “θe” is a rotational angle of the crankshaft 24, and “θc” is the rotational angle of the carrier C. The expression (3) is a motion equation related to the carrier C, and “Tx” is a torque applied to the carrier C from the differential mechanism 30. The expression (4) is a motion equation related to the first rotary electric machine MG1.

Ie*(dωe/dt)=Te-Tc=Te-Kdamp(θe-θc) (2)

Ic*(dωc/dt)=Tc-Tx=Kdamp(θe-θc)-Tx (3)

Img1*(dωmg1/dt)=Tmg1+[ρ/(1+ρ)]*Tx (4)

Then, the following expression (5) is obtained from the above-described expressions (3) and (4). The above-described expression (2) can be transformed into the following expression (6). The above-described expression (1) can be obtained by applying the expression (5) to a term of the spring constant Kdamp of the expression (6).

Kdamp(θe-θc)=Ic*(dωc/dt)+[(1+ρ)/ρ]*[Img1]*(dωmg1/dt)-Tmg1) (5)=

Te=Ie*(dωe/dt)+Kdamp(θe-θc) (6)

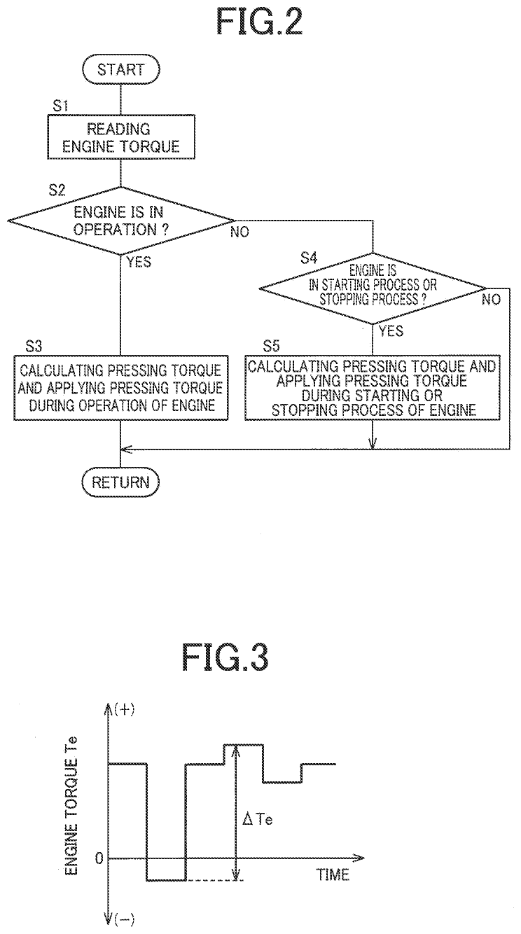

The pressing-torque calculation portion 94b is configured to execute a control routine including steps S1 to S5 that are shown in flowchart of FIG. 2, so as to obtain the pressing torque Tp and to press the gears with the pressing torque Tp for thereby executing a backlash elimination. In the flowchart of FIG. 2, “YES” and “NO” in each of determination steps S1 and S4 (represented by rhombus shapes) represent affirmative determination and negative determination, respectively.

As shown in FIG. 2, the control routine is initiated with step S1 that is implemented to read the engine torque Te obtained by the engine-torque detection portion 94a. The engine-torque detection portion 94a calculates the engine torque Te at a predetermined cycle time, and the calculated engine torque Te is sequentially read at step S1. Then, step S2 and the subsequent steps are implemented. At step S2, it is determined whether or not the engine 12 is in operation, namely, whether or not the engine 12 is in a normal operation in which a predetermined target engine torque Tet is outputted in accordance with the requested drive torque Trdem rather than in a starting process or a stopping process by an intermittent operation. In case of the normal operation, step S3 is implemented to calculate the pressing torque Tp. When the engine 12 is not in the normal operation and a negative determination is made at step S2, step S4 is implemented to determine whether the engine 12 is in the starting process or the stopping process. When the starting process or the stopping process is being executed, step S5 is implemented to calculate the pressing torque Tp. However, when neither the starting process nor the stopping process is being executed, namely, when the operation of the engine 12 is stopped, a negative determination is made at step S4, whereby one cycle of execution of the control routine is terminated, and step S1 and the subsequent steps are repeatedly implemented.

At step S3, the pressing torque Tp is calculated based on the engine torque Te read at step S1. FIG. 3 is a model diagram showing, by way of example, change of the engine torque Te. For example, there is a concern that gear rattle noise may be generated when positive and negative of the engine torque Te are reversed, but even when the positive and negative of the engine torque Te are not reversed, resonance may occur due to torsional deformation of the damper device 26 and the drive shaft 22, for example, and the gear rattle noise may be generated. Therefore, it is not appropriate to determine the pressing torque Tp simply from a value of the engine torque Te. That is, when the gear rattle noise occurred in situation of FIG. 3, it is considered that the gear rattle noise occurred because the engine torque Te was changed from a positive value to a negative value, but it is also considered that the gear rattle noise occurred because a variation width ΔTe of the engine torque Te was large. Therefore, it is necessary to set the pressing torque Tp to a value that is appropriate according to the situation. The variation width ΔTe of the engine torque Te is a difference between a maximum value and a minimum value of the engine torque Te per cycle.

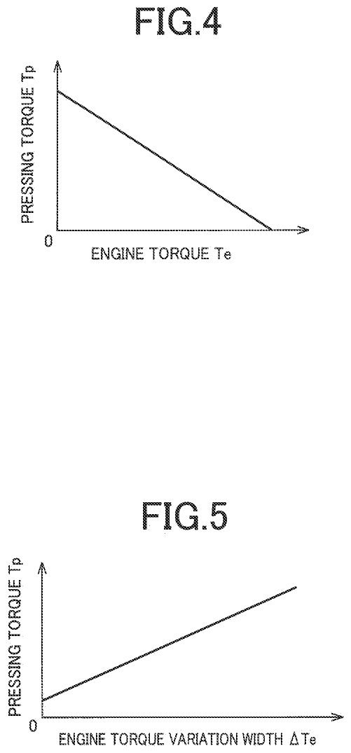

As a method of setting the pressing torque Tp, it is possible to use a method of setting the pressing torque Tp depending on the value of the engine torque Te as shown in the map of FIG. 4 or a method of setting the pressing torque Tp depending on the variation width ΔTe of the engine torque Te as shown in the map of FIG. 5, for example. The pressing torque Tp may be set by using only one of the two methods, or one of the two methods which is selected based on the value or change tendency of the engine torque Te, the operation state of the vehicle 10 such as running or stopping, the running condition, or whether it is desired to suppress one-time tooth-hitting or continuous tooth-hitting. In FIG. 4, the pressing torque Tp is determined in advance by an experiment, a simulation or the like, such that the pressing torque Tp is linearly changed with change of the value of the engine torque Te, and such that the pressing torque Tp becomes larger when the value of the engine torque Te is small than when the value of the engine torque Te is large. As the engine torque Te of FIG. 4, for example, an instantaneous value that is periodically changed as shown in FIG. 3 is used, but an average value for each period may be used. In FIG. 5, the pressing torque Tp is determined in advance by an experiment, a simulation or the like, such that the pressing torque Tp is linearly changed with change of the variation width ΔTe of the engine torque Te, and such that the pressing torque Tp becomes larger when the variation width ΔTe of the engine torque Te is large than when the variation width ΔTe is small. Although the pressing torque Tp is linearly changed in FIGS. 4 and 5, the pressing torque Tp may be changed in various manners such as a polygonal line manner, a non-linear manner or a stepwise manner.

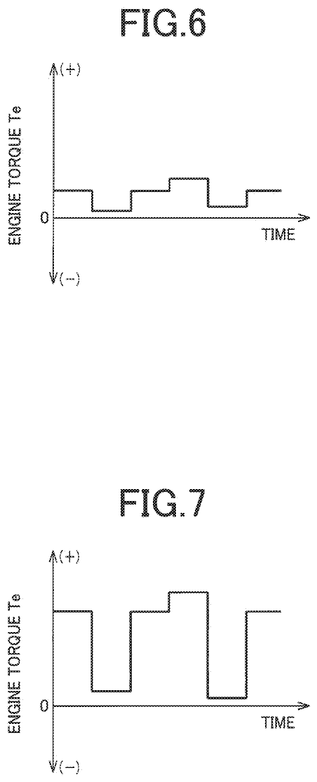

Further, even when the variation width ΔTe of the engine torque Te is small, if the absolute value of the engine torque Te is small as shown in FIG. 6, for example, there is a possibility that the gear rattle noise is generated. In this case, the pressing torque Tp may be applied as a preventive measure for the purpose of suppressing the first tooth-hitting, for example. The pressing torque Tp in this case is set based on the absolute value of the engine torque Te and the variation width ΔTe such that the pressing torque Tp becomes larger as the absolute value of the engine torque Te becomes smaller and the variation width ΔTe becomes larger, for example.

Further, even when the absolute value of the engine torque Te is large, if the variation width ΔTe of the engine torque Te is large as shown in FIG. 7, for example, there is a possibility that the gear rattle noise is generated. In this case, the pressing torque Tp may be applied while the variation width ΔTe is large for the purpose of suppressing continuous tooth hitting, for example. The variation width ΔTe of the engine torque Te becomes large, for example, when a catalyst is warmed up or when a misfire occurs in one cylinder due to a failure. Even if the occurrence of the first tooth-hitting is unavoidable, if the tooth-hitting continues, the vehicle driver feels uneasy or uncomfortable, and therefore it is desirable to suppress the continuous occurrence of the tooth-hitting. The pressing torque Tp in this case is set based on the absolute value of the engine torque Te and the variation width ΔTe such that the pressing torque Tp becomes larger as the absolute value of the engine torque Te becomes smaller and the variation width ΔTe becomes larger, for example.

When the pressing torque Tp has been set (calculated) in this way, by a torque control of at least one of the first rotary electric machine MG1 and the second rotary electric machine MG2, the pressing torque Tp is applied to a portion where there is a possibility of occurrence of the gear rattle noise. The pressing torque Tp may be applied by using one of the first rotary electric machine MG1 and the second rotary electric machine MG2, but if necessary, the pressing torque Tp may be applied by using both the first rotary electric machine MG1 and the second rotary electric machine MG2.

Also at step S5, similarly to step S3, the pressing torque Tp is set based on the engine torque Te, and the pressing torque Tp is applied by using at least one of the first rotary electric machine MG1 and the second rotary electric machine MG2. In this case, there is a possibility that the engine torque Te is unstable and the variation width ΔTe becomes large during the starting process or the stopping process of the engine 12. Therefore, the maps of FIGS. 4 and 5 are determined such that the pressing torque Tp is set to be larger than the pressing torque Tp at step S3 during the normal operation of the engine 12. After the pressing torque Tp is calculated by using the same map as that of step S3, the pressing torque Tp may be increased and corrected.

As described above, the backlash-elimination control portion 94 functionally provided in the electronic control apparatus 90 of the present embodiment detects the engine torque Te and controls the pressing torque Tp based on the engine torque Te, so that it is possible to suppress the gear rattle noise with the minimum necessary pressing torque Tp regardless of the individual difference or the like of the engine 12 and to suppress unnecessary power consumption.

Further, according to the map of FIG. 4, the pressing torque Tp is controlled depending on the value of the engine torque Te, such that the pressing torque Tp is larger when the value of the engine torque Te is small than when the value of the engine torque Te is large, so that it is possible to appropriately suppress the gear rattle noise while suppressing unnecessary power consumption. That is, when the value of the engine torque Te is small, the positive and negative of the engine torque Te are reversed due to the torque variation and the gear rattle noise is likely to occur. Therefore, when the value of the engine torque Te is small, it is possible to appropriately suppress the generation of the gear rattle noise by applying the relatively large pressing torque Tp and suppressing the positive and negative of the engine torque Te from being reversed.

Further, according to the map of FIG. 5, the pressing torque Tp is controlled depending on the variation width ΔTe of the engine torque Te, such that the pressing torque Tp is larger when the variation width ΔTe of the engine torque Te is large than when the variation width ΔTe is small. That is, when the variation width ΔTe of the engine torque Te is large, the gear rattle noise is likely to be generated by the torque variation. Therefore, when the variation width ΔTe of the engine torque Te is large, it is possible to appropriately suppress the generation of the gear rattle noise due to the torque variation, by applying the relatively large pressing torque Tp.

Further, in the present embodiment, there is provided the differential mechanism 30 constituted by the single-pinion-type planetary gear device including the sun gear S connected to the first rotary electric machine MG1, the ring gear R and the carrier C, such that the power outputted from the engine 12 is divided between the first rotary electric machine MG1 and the ring gear R by the differential mechanism 30, and the power transmitted to the ring gear R is outputted toward the drive wheels 14. In this case, the engine torque Te can be calculated in accordance with the above-described expression (1) including the engine term having the angular acceleration (dωe/dt) of the engine 12 as a variable, the career term having the angular acceleration (dωc/dt) of the career C as a variable and the rotary-electric-machine term having the angular acceleration (dωmg1/dt) of the first rotary electric machine MG1 as a variable. In this case, since the angular acceleration (dωc/dt) of the carrier C reflects an input from the drive wheels 14, the engine torque Te can be detected with high accuracy even during running of the vehicle 10 on a rough road or the like. For this reason, it becomes possible to appropriately detect a reduction or variation of the engine torque Te caused by, for example, a misfire in one cylinder of the engine 12, and to appropriately suppress generation of gear rattle noises by controlling the pressing torque Tp based on the engine torque Te.

Although the embodiment of the present invention has been described in detail with reference to the drawings, the embodiment is merely an embodiment, and the present invention can be carried out with various modifications and improvements based on the knowledge of those skilled in the art.

### NOMENCLATURE OF ELEMENTS

10: vehicle
12: engine
14: drive wheel
26: damper device
30: differential mechanism (planetary gear device)
50: gear-type power transmission device
90: electronic control apparatus (control apparatus)
94: backlash-elimination control portion
MG1: first rotary electric machine
MG2: second rotary electric machine
Te: engine torque
ΔTe: variation width of engine torque
Tp: pressing torque

What is claimed is:

1. A control apparatus for a vehicle that includes a drive wheel, an engine, a gear-type power transmission device disposed between the engine and the drive wheel, and a rotary electric machine connected to the gear-type power transmission device in a power transmittable manner,
wherein the rotary electric machine is configured to apply a pressing torque in order to suppress rattle noise caused by play between gears of the gear-type power transmission device, and
wherein the control apparatus is configured to detect an engine torque that is a torque of the engine, and to control the pressing torque based on the engine torque.

2. The control apparatus according to claim 1,
wherein the control apparatus is configured to control the pressing torque, depending on a value of the engine torque, such that the pressing torque is larger when the value of the engine torque is small than when the value of the engine torque is large.

3. The control apparatus according to claim 1,
wherein the control apparatus is configured to obtain a variation width of the engine torque, and to control the pressing torque, depending on the variation width of the engine torque, such that the pressing torque is larger when the variation width is large than when the variation width is small.

4. The control apparatus according to claim 1,
wherein the vehicle includes a first rotary electric machine and a second rotary electric machine as the rotary electric machine, such that the pressing torque is applied by at least one of the first rotary electric machine and the second rotary electric machine,
wherein the gear-type power transmission device is provided with a single-pinion-type planetary gear device including (i) a sun gear connected to the first rotary electric machine, (ii) a carrier connected to the engine via a damper device and (iii) a ring gear, such that the second rotary electric machine is connected between the ring gear and the drive wheel in a power transmittable manner, and such that a power outputted from the engine is distributed to the first rotary electric machine and the ring gear by the planetary gear device, and the power transmitted to the ring gear is outputted toward the drive wheel, and
wherein the control apparatus is configured to calculate the engine torque in accordance with an arithmetic expression that includes (a) an engine term including an angular acceleration of the engine as a variable, (b) a carrier term including an angular acceleration of the carrier as a variable and (c) a rotary-electric-machine term including an angular acceleration of the first rotary electric machine as a variable.

5. The control apparatus according to claim 4,
wherein the control apparatus is configured to calculate the engine torque Te in accordance with the following expression using an inertia moment Ie and an angular velocity we of the engine, an inertia moment Ic and an angular velocity ωc of the carrier, an inertia moment Img1, an angular velocity ωmg1 and a torque Tmg1 of the first rotary electric machine, and a gear ratio ρ of the planetary gear device.
Te=Ie*(dωe/dt)+Ic*(dωc/dt)+[(1+ρ)/ρ]*[Img1*(dωmg1/dt)−Tmg1]
